(19) United States
(12) Patent Application Publication
(10) Pub. No.: US 2025/0092202 A1
(43) Pub. Date: Mar. 20, 2025

(54) FUNCTIONALIZED POLY(ARYL ETHER SULFONES) COPOLYMERS

(71) Applicant: Solvay Specialty Polymers USA, LLC, Alpharetta, GA (US)

(72) Inventor: Kamlesh NAIR, Alpharetta, GA (US)

(21) Appl. No.: 18/727,710

(22) PCT Filed: Jan. 18, 2023
(86) PCT No.: PCT/EP2023/051150

§ 371 Date: Jul. 10, 2024

Related U.S. Application Data
(60) Provisional application No. 63/300,668, filed on Jan. 19, 2022.

(30) Foreign Application Priority Data
Mar. 18, 2022 (EP) 22162979.3

(51) Int. Cl. C08G 75/23

(52) U.S. Cl. CPC C08G 75/23

(57) ABSTRACT

The invention relates to an allyl/vinylene-functionalized copolymer (P0), a process for preparing the allyl/vinylene-functionalized copolymer (P0), a side-chain functionalized copolymer (P1) and a process for preparing such copolymer (P1) from the copolymer (P0). The present invention also relates to the use of the copolymer (P1) in the preparation of a membrane, a composite material or a coating.

### CROSS-REFERENCE TO RELATED APPLICATIONS

This application claims priority to U.S. provisional patent application No. 63/300,668 filed on Jan. 19, 2022 and European patent application No. 22162979.3 filed on Mar. 18, 2022, the whole content of these applications being incorporated herein by reference for all purposes

### TECHNICAL FIELD

The present disclosure relates to an allyl/vinylene-functionalized copolymer (P0), a process for manufacturing the copolymer (P0), a side-chain functionalized copolymer (P1) and a process for preparing the side-chain functionalized copolymer (P1) from the copolymer (P0). The present invention also relates to the use of the copolymer (P1) for preparing functional membranes, i.e. hydrophobic, hydrophilic, bio-labeled, membranes with fluorescent tags, the use of the copolymer (P1) in composite materials, 3D printing applications, and the use of the copolymer (P1) in functional coatings.

### BACKGROUND ART

Poly(aryl ether sulfones) (PAES) polymers belong to the group of high-performance thermoplastics and are characterized by high heat distortion resistance, good mechanical properties, excellent hydrolytic resistance and an inherent flame retardance. Versatile and useful, PAES polymers have many applications in electronics, electrical industry, medicine, general engineering, food processing and 3D printing.

While PAES polymers have many advantages, and good physical properties, it is sometimes desirable to tune these properties to improve performance in specific applications. For example, in membrane filtration, increasing the hydrophilicity of PAES is sometimes desired to improve key membrane performance attributes such as flow rate. Basic property modification, including but not limited to hydrophilicity, is oftentimes achieved by combining two homopolymers to make block copolymers that possess the combination of intrinsic properties of each individual homopolymer. For example, in membrane applications, a PAES homopolymer can be covalently linked to a hydrophilic homopolymer to synthesize a new PAES-hydrophilic block copolymer possessing superior membrane performance owing to the enhanced wettability caused by the hydrophilic component while retaining the mechanically robust and amorphous pore structure of the PAES component.

The present invention provides a side-chain functionalized copolymer and a process for preparing such copolymers. These functionalized copolymers are complex polymer architectures useful in may different applications, for instance to prepare membranes, composite materials and coatings.

### SUMMARY OF INVENTION

The present invention provides a way to introduce functionality in the PAES polymers and is set out in the appended set of claims.

A first aspect of the present disclosure is directed to a poly(aryl ether sulfone) (PAES) copolymer (P0), as defined in any one of claims 1-6, comprising allyl and/or functional groups comprising carbon-carbon double bonds which are reactive and can therefore be used to efficiently modify copolymers.

A second aspect of the present disclosure is directed to a side-chain functionalized poly(aryl ether sulfone) (PAES) copolymer (P1) as defined in any one of claims 10-16. The copolymer (P1) comprises poly(aryl ether sulfone) (PAES) recurring units (R_{P1}), as well as PAES recurring units (R*_{P1}) with pendant groups, more precisely PAES recurring units functionalized with side-chain groups. Recurring units (R*_{P1}) contain a thio-ether functional group which possesses several advantages. It is a hydrolytically and chemically stable but at the same time versatile functional group which can be easiliy modified to fine tune the properties of the PAES polymer.

A third aspect of the present disclosure is directed to a process for manufacturing the PAES copolymer (P0) as defined in any one of claims 7 to 9.

A fourth aspect of the present disclosure is directed to a process for preparing the PAES copolymer (P1), as defined in any one of claims 17 and 18, from the PAES copolymer (P0) comprising allyl and/or functional groups comprising carbon-carbon double bonds which are reactive with a mercaptan compound.

A fifth aspect of the present disclosure is directed to the use of resulting PAES copolymers (P1), as defined in claim 19, in various applications, for example to prepare membranes such as functional membranes, e.g., hydrophobic, hydrophilic, bio-labeled, membranes with fluorescent tags, in composite materials, in 3D printing applications, and/or in coatings such as functional coatings.

More precisions and details about these subject matters are now provided below.

### DETAILED DESCRIPTION

### Definitions

In the present application:
any description, even though described in relation to a specific embodiment, is applicable to and interchangeable with other embodiments of the present disclosure, and each embodiment thus defined may be combined with another embodiment, unless otherwise indicated or clearly incompatible;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list;
any recitation herein of numerical ranges by endpoints includes all numbers subsumed within the recited ranges as well as the endpoints of the range and equivalents;
the term “comprising” (or “comprise”) includes “consisting essentially of” (or “consist essentially of”) and also “consisting of” (or “consist of”); and
the use of the singular ‘a’ or ‘one’ herein includes the plural unless specifically stated otherwise; and
it should be understood that the elements, properties and/or the characteristics of a (co)polymer, product or article, a process or a use, described in the present specification, may be combined in all possible ways with the other elements, properties and/or characteristics of the (co)polymer, product or article, process or use, explicitly or implicitly, this being done without departing from the scope of the present description.

### Copolymer (P0)

The copolymer (P0) of the present invention comprises recurring units (R*_{P0}) with 2 pendant allyl/vinylene side-chains, which are reactive with a compound R₂—SH.

The copolymer (P0) more precisely comprises:
recurring units (R_{P0}) of formula (M):

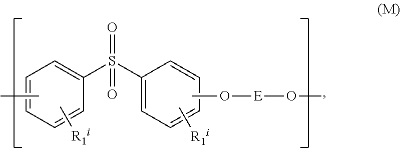

recurring units (R*_{P0}) of formula (P):

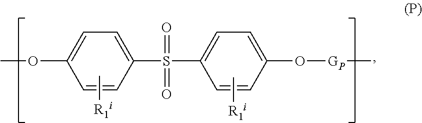

wherein
   each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
   each i is independently selected from 0 to 4;
   each of E, equal to or different from each other and at each occurrence, is selected from the group consisting of those of formulae (E′-I), (E′-II), (E′-III), (E′-IV), (E′-Va) and (E′-Vb):

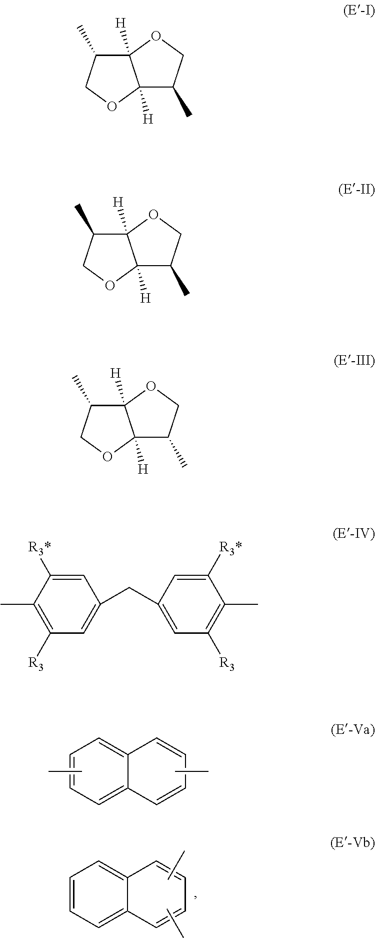

each R₃ is at each location independently selected from H or an alkyl having from 1 to 5 carbon atoms, preferably an alkyl having from 1 to 5 carbon atoms, more preferably methyl at each location;
each R₃*is at each location independently selected from an alkyl having from 1 to 5 carbon atoms, preferably methyl at each location;
G_{P} is selected from the group consisting of at least one of the following formulae (G_{P1}), (G_{P2}) and (G_{P3}):

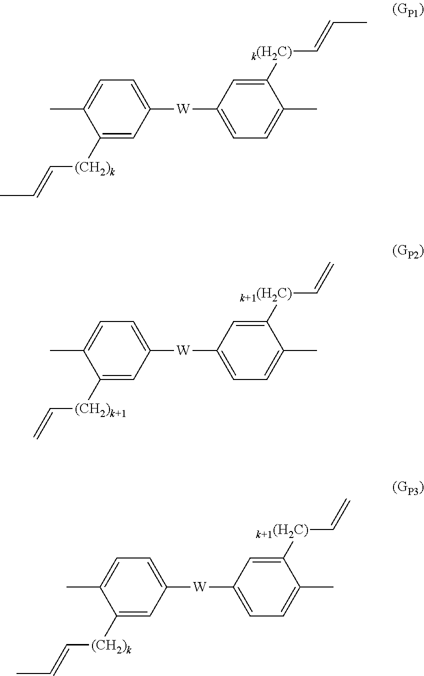

wherein
   W is a bond, —C(CH₃)₂— or —SO₂—, preferably —C(CH₃)₂— or —SO₂—; and
   each k is independently 0 or an integer from 1 to 4.

In some embodiments, the copolymer (P0) is such that k is zero in recurring units (R*_{P0}).

In some embodiments, the copolymer (P0) is such that i is zero for each R₁ of recurring units (R_{P0}) and recurring units (R*_{P0}).

In some embodiments, the recurring units (R_{P0}) may be according to any of the formulae (M1), (M2), (M3), preferably formula (M1), shown below:

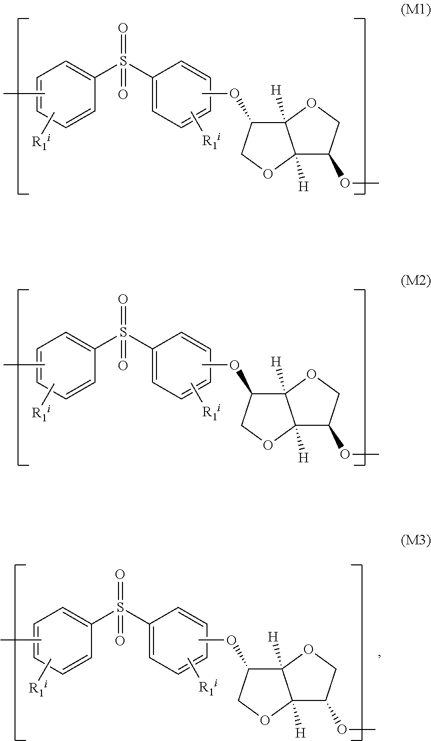

wherein
   each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
   each i is independently 0 or an integer from 1 to 4, preferably i=0.

In some embodiments, the recurring units (R_{P0}) may be according to formula (M1) wherein i=0.

In some embodiments, the recurring units (R_{P0}) may be according to the formula (M4), shown below:

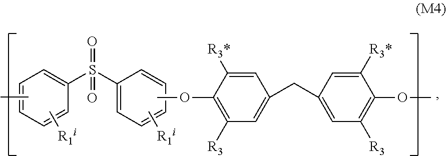

wherein
   each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
   each i is independently 0 or an integer from 1 to 4, preferably i=0;
   each R₃ is at each location independently selected from H or an alkyl having from 1 to 5 carbon atoms, preferably an alkyl having from 1 to 5 carbon atoms, more preferably methyl at each location, and
   each R₃*is at each location independently selected from an alkyl having from 1 to 5 carbon atoms, preferably methyl at each location.

In some embodiments, the recurring units (R_{P0}) may be according to the formula (M4′), as shown below:

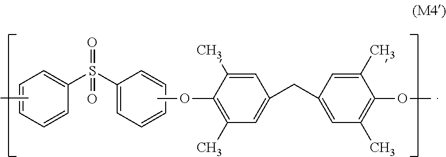

In some embodiments, the recurring units (R_{P0}) may be according to the formula (M5a) or (M5b), as shown below:

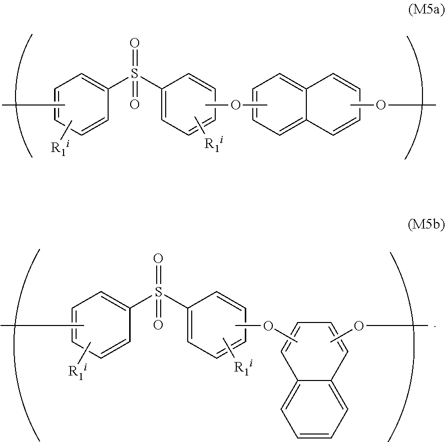

In some embodiments, the recurring units (R_{P0}) may be according to the formula (M5a′) or (M5b′), as shown below:

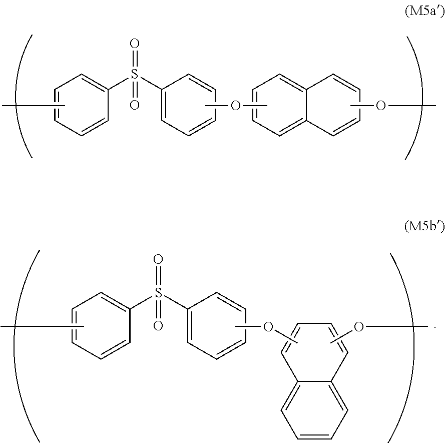

In some embodiments, the recurring units (R_{P0}) comprise at least one of the recurring units of formula (M) with E being of formula (E′-Va) and/or (E′-Vb) selected from the group consisting of:

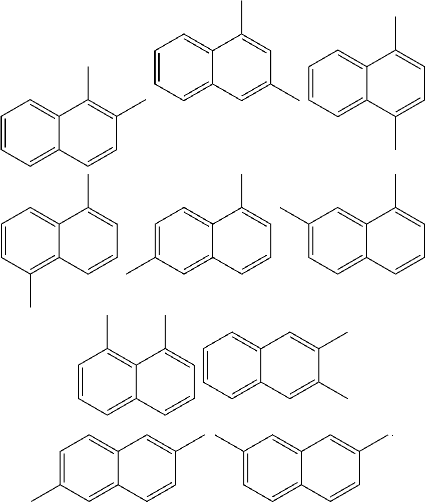

In some embodiments, the recurring units (R_{P0}) may be according to any of the formulae (M1) wherein i=0, (M4′), (M5a′), (M5b′), or any combinations thereof.

In some embodiments, the recurring units (R_{P0}) comprise at least one of the following units:
the recurring units of formula (M) with E being of formula (E′-I);
the recurring units of formula (M) with E being of formula (E′-IV), preferably wherein R₃ and R*₃ in formula (E′-IV) are methyl groups;
the recurring units of formula (M) with E being of formula (E′-Va) and/or (E′-Vb), preferably selected from:

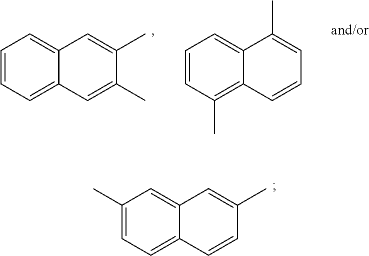

or
   any combination thereof.

In some embodiments, the recurring units (R_{P0}) comprise at least one of the following units:
the recurring units of formula (M) with E being of formula (E′-I);
the recurring units of formula (M) with E being of formula (E′-IV), preferably wherein R₃ and R*₃ in formula (E′-IV) are methyl groups; or
any combination thereof.

In some embodiments, the copolymer (P0) is such that W in recurring units (R*_{P0}) is selected from the group consisting of a bond, —SO₂—, —C(CH₃)₂— and a mixture therefrom. W in recurring units (R*_{P0}) is preferably —C(CH₃)₂— and/or —SO₂—. The copolymer (P0) may, for example, comprise first recurring units (R*_{P0}) in which W is —C(CH₃)₂— and second recurring units (R*_{P0}) in which W is —SO₂—.

In some embodiments, the copolymer (P0) is such that each R₁ is independently selected from the group consisting of a C1-C12 moiety optionally comprising one or more than one heteroatoms; sulfonic acid and sulfonate groups; phosphonic acid and phosphonate groups; amine and quaternary ammonium groups.

In some embodiments, the copolymer (P0) may be such that the molar ratio of recurring units (R_{P0})/recurring units (R*_{P0}) varies between 1/1 and 20/1, preferably between 1/1 and 12/1, more preferably between 1/1 and 10/1, or betwwen 4/1 and 12/1 or between 4/1 and 10/1.

The molar ratio of recurring units (R_{P0})/recurring units (R*_{P0}) is preferably at least 2.4/1, or at least 3/1, or at least 4/1 and/or at most 25/1, or at most 24/1, or at most 20/1, or at most 12/1, or at most 11/1. In other words, the content of recurring units (R*_{P0}) is preferably at most 29 mol. %, or at most 25 mol. %, or at most 20 mol. %, and/or at least 4 mol. %, or at least 4.75 mol. %, or at least 7.7 mol. %, or at least 8.33 mol. %, or at least 9 mol. %, said mol. % being relative to the total number of moles of recurring units (R*_{P0}) and recurring units (R*_{P0}) in the copolymer (P0).

In some embodiments, the copolymer (P0) comprises collectively at least 50 mol. % of recurring units (R_{P0}) and (R*_{P0}), based on the total number of moles in the copolymer (P0). The copolymer (P0) may for example comprise collectively at least 60 mol. %, at least 70 mol. %, at least 80 mol. %, at least 90 mol. %, at least 95 mol. %, or at least 99 mol. % of recurring units (R_{P0}) and (R*_{P0}), based on the total number of moles of recurring units in the copolymer (P0). The copolymer (P0) may preferably consist essentially of recurring units (R_{P0}) and (R*_{P0}).

According to an embodiment, the copolymer (P0) of the present invention has a Tg ranging from 100 and 290° C., preferably from 170 and 240° C., more preferably from 180 and 230° C., as measured by differential scanning calorimetry (DSC) according to ASTM D3418.

### Process for Preparing Copolymer (P0)

In some embodiments, the allyl/vinylene-functionalized copolymer (P0) of the present invention can be prepared by condensation of at least one aromatic dihydroxy monomer (a1), with at least one aromatic sulfone monomer (a2) comprising at least two halogen substituents and at least one allyl-substituted aromatic dihydroxy monomer (a3). The reaction mixture preferably comprises at least monomers (a1), (a2) and (a3).

The condensation to prepare the copolymer (P0) is preferably carried out in a reaction mixture comprising the monomers (a1), (a2) and (a3) and at least one solvent. When the condensation to prepare copolymer (P0) is carried out in a solvent S₀, the solvent S₀ is for example a polar aprotic solvent selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof. The polar aprotic solvent S₀ is preferably selected from the group consisting of N-methylpyrrolidone (NMP), N-butylpyrrolidone (NBP), N-ethyl-2-pyrrolidone, N,N-dimethylformamide (DMF), N,N dimethylacetamide (DMAc), 1,3-dimethyl-2-imidazolidinone, tetrahydrofuran (THF), dimethyl sulfoxide (DMSO), chlorobenzene, anisole and sulfolane. The solvent S₀ may also be chloroform or dichloromethane (DCM). The reaction to prepare copolymer (P0) is more preferably carried out in sulfolane or NMP.

The condensation to prepare copolymer (P0) may be carried out in the presence of a base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (CS₂CO₃) and sodium tert-butoxide. The base acts to deprotonate the components (a1) and (a3) during the condensation reaction.

The condensation to prepare copolymer (P0) may be carried out with a molar ratio (a1)+(a3)/(a2) from 0.9 to 1.1, for example from 0.92 to 1.08 or from 0.95 to 1.05.

In some embodiments, the molar ratio of dihydroxy monomer (a1)/monomer (a3) varies between 1/1 and 20/1, preferably between 1/1 and 12/1, more preferably between 1/1 and 10/1, or betwwen 4/1 and 12/1, or between 4/1 and 10/1.

The molar ratio of dihydroxy monomer (a1)/monomer (a3) is preferably at least 2.4/1, or at least 3/1, or at least 4/1 and/or at most 25/1, or at most 24/1, or at most 20/1, or at most 12/1, or at most 11/1. In other words, the amount of monomer (a3) is preferably at most 29 mol. %, or at most 25 mol. %, or at most 20 mol. %, and/or at least 4 mol. %, or at least 4.75 mol. %, or at least 7.7 mol. %, or at least 8.33 mol. %, or at least 9 mol. %, said mol. % being relative to the total number of moles of dihydroxy monomer (a1) and monomer (a3).

In some embodiments, the monomer (a1) comprises, based on the total weight of the monomer (a1), at least 50 wt. % of at least one diol selected from the group consisting of: isosorbide (1), isomannide (2), isoidide (3), alkyl-substituted Bisphenol F (4), and naphthalene diol (5) and/or (5*):

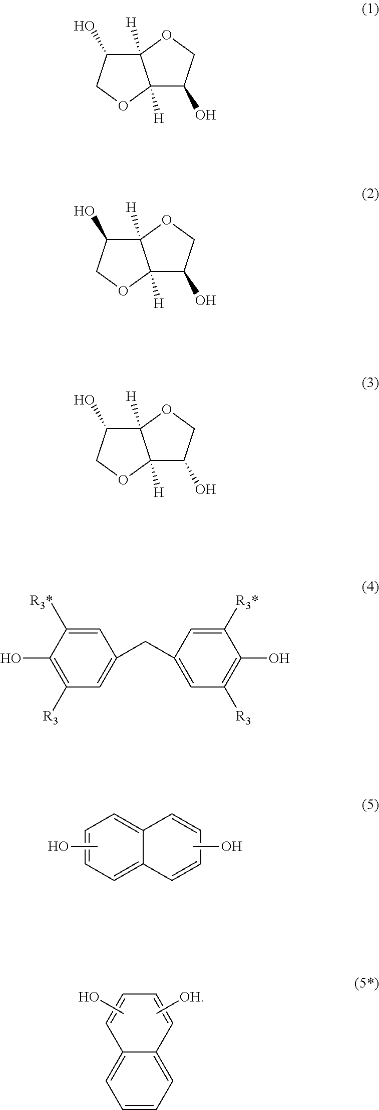

The monomer (a1) may for example comprise, based on the total weight of the monomer (a1), at least 60 wt. %, at least 70 wt. %, at least 80 wt. %, at least 90 wt. %, at least 95 wt. %, at least 99 wt. % of at least one diol selected from formulae (1), (2), (3), (4), (5) and (5*). The monomer (a1) may preferably consist essentially at least one diol selected from formulae (1), (2), (3), (4), (5) and (5*) or consist essentially at least one diol selected from formulae (1), (2), (3) and (4). The monomer (a1) may more preferably consist essentially at least one diol selected from formulae (1) and (4).

In some embodiments, the monomer (a1) may comprise, based on the total weight of the monomer (a1), at least 50 wt. % of the naphthalene diol (5) or (5*) selected from the group consisting of isomers of formulae (5a) to (5j):

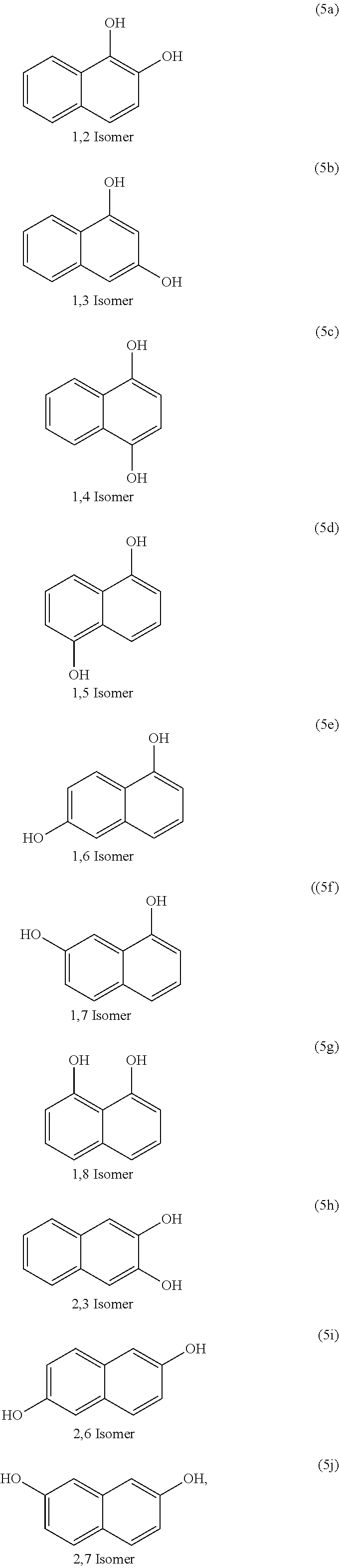

preferably selected from the group consisting of 1,5 isomer of formula (5d), 2,3 isomer of formula (5h) and 2,7 isomer of formula (5j), more preferably selected from the group consisting of 1,5 isomer of formula (5d) and 2,7 isomer of formula (5j). The monomer (a1) may for example comprise, based on the total weight of the monomer (a1), at least 60 wt. %, at least 70 wt. %, at least 80 wt. %, at least 90 wt. %, at least 95 wt. %, at least 99 wt. % of naphthalene diol (5) and/or (5*) selected from the group consisting of isomers of formulae (5a) to (5j). The monomer (a1) may preferably consist essentially of the naphthalene diol (5) and/or (5*) selected from the group consisting of isomers of formulae (5a) to (5j), more preferably consist essentially of the naphthalene diol (5) and/or (5*) selected from the group consisting of isomers of formulae (5d) and (5j).

In some embodiments, the monomer (a1) may comprise at least 50 wt. %, based on the total weight of the monomer (a1), or consists of, of at least one diol selected from the group consisting of: isosorbide (1), alkyl-substituted Bisphenol F (4) with R₃, R₃* being methyl groups; and naphthalene diol (5) being 1,5 isomer of formula (5d), 2,3 isomer of formula (5h), and/or 2,7 isomer of formula (5j), preferably being 1,5 isomer of formula (5d) and/or 2,7 isomer of formula (5j). The monomer (a1) may preferably comprises at least 50 wt. %, based on the total weight of the monomer (a1), or consists of, of at least one diol selected from the group consisting of: isosorbide (1) and alkyl-substituted Bisphenol F (4) with R₃, R₃* being methyl groups. The monomer (a1) may for example comprise, based on the total weight of the monomer (a1), at least 60 wt. %, at least 70 wt. %, at least 80 wt. %, at least 90 wt. %, at least 95 wt. %, at least 99 wt. % of at least one of these particular diols.

In some embodiments, the monomer (a2) comprises at least 50 wt. %, based on the total weight of the monomer (a2) of at least one 4,4-dihalosulfone:

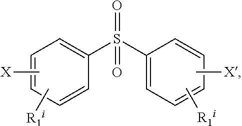

wherein
   each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
   each i is independently 0 or an integer from 1 to 4; and
   X and X′ are independently a halogen selected from the group consisting of Cl and F.

In some embodiments, the monomer (a2) preferably comprises at least 50 wt. %, based on the total weight of the monomer (a2), or consists of, 4,4′-dichlorodiphenyl sulfone (DCDPS) and/or 4,4′ difluorodiphenyl sulfone (DFDPS), more preferably comprises or consists of DCDPS.

In some embodiments, the monomer (a2) may for example comprise, based on the total weight of the monomer (a2), at least 60 wt. %, at least 70 wt. %, at least 80 wt. %, at least 90 wt. %, at least 95 wt. %, at least 99 wt. % of the at least one 4,4-dihalosulfone, preferably DCDPS or DFDPS, more preferably DCDPS. The monomer (a2) may preferably consist essentially of DCDPS or DFDPS, more preferably DCDPS.

In some embodiments, the monomer (a3) comprises at least 50 wt. %, based on the total weight of the monomer (a3), or consists of, of a 2,2′-diallyl diol selected from the group consisting of any of following formulae (G_{M1}), (G_{M2}) and (G_{M3}):

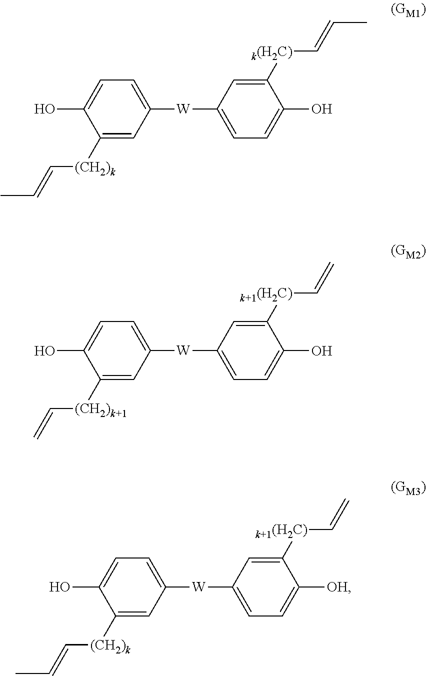

wherein W is a bond, —C(CH₃)₂— or —SO₂—, preferably —C(CH₃)₂— or —SO₂— and each k is independently 0 or an integer from 1 to 4.

In some embodiments, the monomer (a3) comprises at least 50 wt. %, based on the total weight of the monomer (a3), or consists of, of the following 2,2′-diallyl diol:

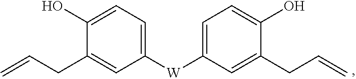

wherein W is a bond, —C(CH₃)₂— and/or —SO₂—, preferably W is —C(CH₃)₂— and/or —SO₂—. In other words, the monomer (a3) comprises at least 50 wt. %, based on the total weight of the monomer (a3), or consists of, of 2,2′-diallyl biphenol (daBP), 2,2′-diallyl bisphenol A (daBPA), and/or 2,2′-diallyl bisphenol S (daBPS), preferably daBPA and/or daBPS.

The monomer (a3) may for example comprise, based on the total weight of the monomer (a3), at least 60 wt. %, at least 70 wt. %, at least 80 wt. %, at least 90 wt. %, at least 95 wt. %, at least 99 wt. % of any 2,2′-diallyl diol of formulae (G_{M1}), (G_{M2}) and (G_{M3}), preferably daBP, daBPA and/or daBPS.

According to the condensation to prepare the copolymer (P0), the monomers (a1), (a2) and (a3) of the reaction mixture are generally reacted concurrently. The reaction is preferably conducted in one stage. This means that the deprotonation of monomers (a1) and (a3) and the condensation reaction between the monomers (a1)+(a3) and (a2) takes place in a single reaction stage without isolation of intermediate products.

According to an embodiment, the condensation is carried out in a mixture of a polar aprotic solvent S₀ and a co-solvent which forms an azeotrope with water. The co-solvent which forms an azeotrope with water includes aromatic hydrocarbons such as benzene, toluene, xylene, ethylbenzene, chlorobenzene and the like. The co-solvent is preferably toluene or chlorobenzene. The azeotrope forming co-solvent and polar aprotic solvent S₀ are used typically in a weight ratio of from about 1:20 to about 1:1 or from about 1:10 to about 1:1, preferably from about 1:5 to about 1:1. Water is continuously removed from the reaction mass as an azeotrope with the azeotrope forming co-solvent so that substantially anhydrous conditions are maintained during the polymerization. The azeotrope-forming co-solvent, for example, chlorobenzene or toluene, is removed from the reaction mixture, typically by distillation, after the water formed in the reaction is removed leaving the copolymer (P0) dissolved in the polar aprotic solvent.

The temperature of the reaction mixture to prepare the copolymer (P0) is kept at about 150° C. to about 350° C., preferably from about 210° C. to about 300° C. for about one to 15 hours.

The inorganic constituents, for example sodium chloride or potassium chloride or excess of base, can be removed, before or after isolation of the copolymer (P0), by suitable methods such as dissolving and filtering, screening or extracting.

According to an embodiment, the amount of the copolymer (P0) at the end of the condensation is at least 30 wt. % based on the total weight of the copolymer (P0) and the polar aprotic solvent, for example at least 35 wt. % or at least or at least 37 wt. % or at least 40 wt. %.

At the end of the reaction, the copolymer (P0) is separated from the other components (salts, base, . . . ) to obtain a solution. Filtration can for example be used to separate the copolymer (P0) from the other components.

The solution containing the copolymer (P0) can then be used as such for reacting the copolymer (P0) with a compound R₂—SH in a process of the present invention to manufacture the copolymer (P1) which is described later. Alternatively, the copolymer (P0) can be recovered in solid form from the solvent S₀ (used during condensation), for example by coagulation or devolatilization of the solvent S₀. The copolymer (P0) in solid form may be dissolved in a solvent S₁ (same or different than S₀) used for the manufacture of the copolymer (P1).

In preferred embodiments, the copolymer (P0) according to the invention is an intermediate product used for the preparation of the copolymer (P1) according to the invention.

### Copolymer (P1)

The present invention also relates to a side-chain functionalized copolymer (P1). This copolymer (P1) comprises at least two types of recurring units, namely recurring units (R_{P1}) of formula (M) and recurring units (R*_{P1}) of formula (N), described below.

The recurring units (R*_{P1}) are functionalized with functional groups which can be selected from:
(CH₂)ⱼ—S—R₂ wherein j varies between 3 and 7 and/or
(CH₂)ₖ—CH ((CH₂)—CH₃)—S—R₂ wherein k varies between 0 and 4, and R₂ is independently selected from the group consisting of:
   (CH₂)ᵤ—COOH, with u being an integer from 1 to 5,
   (CH₂)ₖ—OH, with k′ being an integer from 1 to 5,
   (CH₂)ₚ—NRₐR_{b}, with p being an integer from 1 to 5, and a and b being independently a C1-C6 alkyl or H, with the proviso that Rₐ and R_{b} cannot be both CH₃,
   (CH₂)_{q}—SO₃Na, with q being an integer from 1 to 5,
   (CH₂)ₐ—COCH₃, with a being an integer from 0 to 10
   (CH₂)ᵣ—Si (OCH₃)₃, with r being an integer from 1 to 5,
   (CH₂)ₛ—(CF₂)ₜ—CF₃, with s being an integer from 1 to 5 and t being an integer from 1 to 10,
   C(O)— R_{c}, with R_{c} being a C1-C6 alkyl or H, preferably H,
   (CH₂)ᵥ—CH₃, with v being an integer from 5 to 30, and
   (CH₂)_{w}—Ar, with w being an integer from 1 to 10 and Ar comprising one or two aromatic or heteroaromatic rings.

The functional groups of copolymer (P1) are internal functionalizations, within the copolymer backbone. The internal functionalizations result from a step-growth polymerization, in the presence of an allyl-substituted monomer, which advantageously makes the system versatile as the content of functionality can be adjusted by varying the content of allyl-substituted monomer in the reaction mixture. The allyl-substituted monomer comprises two pendant allyl group side chains which according to the present invention each comprises from 3 to 7 carbon atoms.

The copolymer (P1) of the present invention comprises:
recurring units (R_{P1}) of formula (M):

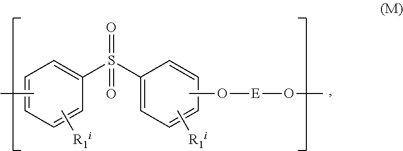

recurring units (R*_{P1}) of formula (N):

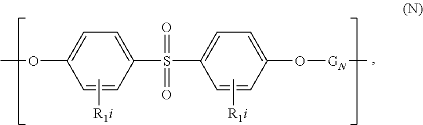

wherein
   each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
   each i is independently selected from 0 to 4;
   each of E, equal to or different from each other and at each occurrence, is selected from the group consisting of those of formulae (E′-I), (E′-II), (E′-III), (E′-IV), (E′-Va) and (E′-Vb), preferably selected from the group consisting of those of formulae (E′-I), (E′-II), (E′-III) and (E′-IV), as previously described in relation to recurring units (R_{P0});
   G_{N} is selected from the group consisting of at least one of the following formulae (G_{N1}) to (G_{N6}):

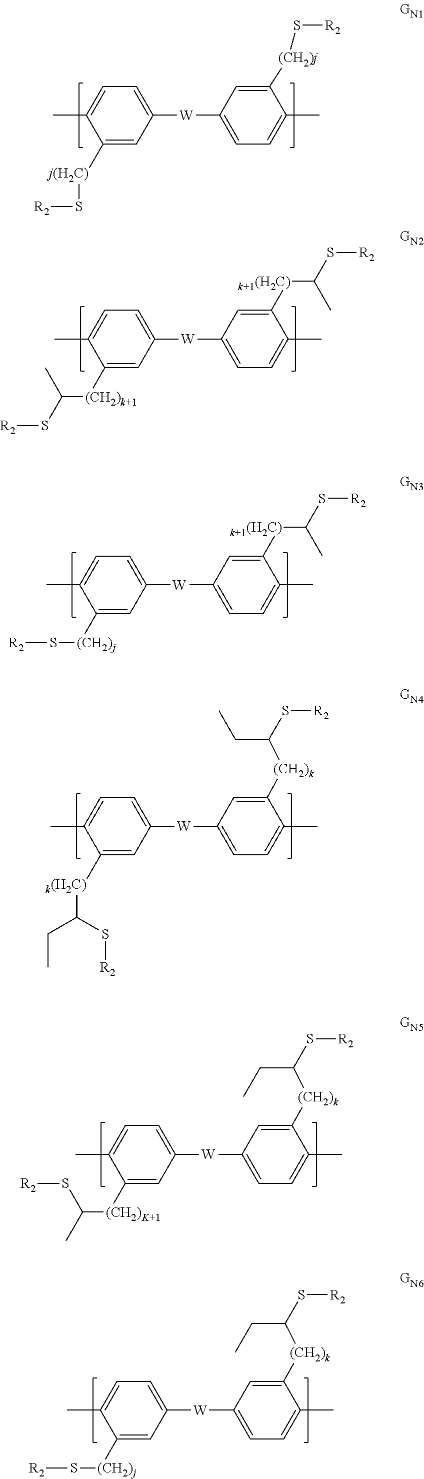

in which
   W is a bond, —C(CH₃)₂— or —SO₂—, preferably —C(CH₃)₂— or —SO₂—;
   each k is independently 0 or an integer from 1 to 4;
   each j is independently an integer from 3 to 7;
   each R₂ is independently selected from the group consisting of:
(CH₂)ᵤ—COOH, with u being an integer from 1 to 5,
(CH₂)_{k′}—OH, with k′ being an integer from 1 to 5,
(CH₂)ₚ—NRₐR_{b}, with p being an integer from 1 to 5, and a and b being independently a C1-C6 alkyl or H, with the proviso that Rₐ and R_{b} cannot be both CH₃,
(CH₂)_{q}—SO₃Na, with q being an integer from 1 to 5,
(CH₂)ₐ—COCH₃, with a being an integer from 0 to 10,
(CH₂)ᵣ—Si (OCH₃)₃, with r being an integer from 1 to 5,
(CH₂)ₛ—(CF₂)ₜ—OF₃, with s being an integer from 1 to 5 and t being an integer from 1 to 10,
C(O)— R_{c}, with Rₑ being a C1-C6 alkyl or H, preferably H,
(CH₂)ᵥ—CH₃, with v being an integer from 5 to 30, and
(CH₂)_{w}—Ar, with w being an integer from 1 to 10 and Ar comprising one or two aromatic or heteroaromatic rings.

The copolymer (P1) is preferably such that R₂ in recurring units (R*_{P1}) is independently selected from the group consisting of:
CH₂— COOH,
(CH₂)₂—OH,
(CH₂)₂—NH₂,
(CH₂)₃—SO₃Na,
(CH₂)₃—Si (OCH₃)₃,
(CH₂)₂—(CF₂)₇— CF₃,
CHO,
(CH₂)₉—CH₃, and
CH₂-Ph with Ph being benzene ring.

The copolymer (P1) of the present invention is in the form of a racemate product. Due to the presence of the base and high temperature during polymerization, the allyl-substituted monomer usually racemizes during polymerization in such a way that the position of the double bond may change along the side chains. This leads to the formation of molecules differing from each others by the fact that the double bond may be at the end of the side chain or one carbon before the end of the side chain. The amount of racemization depends on the reaction time and temperature.

In some embodiments, the copolymer (P1) is such that each R₁ is independently selected from the group consisting of a C1-C12 moiety optionally comprising one or more than one heteroatoms; sulfonic acid and sulfonate groups; phosphonic acid and phosphonate groups; amine and quaternary ammonium groups.

In some embodiments, the copolymer (P1) is such that i is zero for each R₁ of recurring units (R_{P1}) and recurring units (R*_{P1}).

In some embodiments, the copolymer (P1) is such that recurring units (R_{P1}) are according to any of the formulae (M1), (M2), (M3), preferably according to formula (M1), as previously shown in relation to recurring units (R_{P0}).

In some embodiments, the copolymer (P1) is such that recurring units (R_{P1}) are according to formula (M1) wherein i=0.

In some embodiments, the copolymer (P1) is such that recurring units (R_{P1}) are according to the formula (M4), as previously described in relation to recurring units (R_{P0}).

In some embodiments, the copolymer (P1) is such that recurring units (R_{P1}) are according to the formula (M4′), as previously described in relation to recurring units (R_{P0}).

In some embodiments, the copolymer (P1) is such that recurring units (R_{P1}) are according to the formula (M5a) and/or (M5b), as previously described in relation to recurring units (R_{P0}).

In some embodiments, the copolymer (P1) is such that recurring units (R_{P1}) are according to the formula (M5a′) and/or (M5b′), as previously described in relation to recurring units (R_{P0}).

In some embodiments, the copolymer (P1) may be such that the recurring units (R_{P1}) are according to any of the formulae (M1) wherein i=0, (M4′), (M5a′), (M5b′) or any combination thereof.

In some embodiments, the recurring units (R_{P1}) comprise at least one of the following units:
the recurring units of formula (M) with E being of formula (E′-I), preferably with i=0;
the recurring units of formula (M) with E being of formula (E′-IV), preferably wherein R₃ and R*₃ in formula (E′-IV) are methyl groups;
the recurring units (R_{P1}) comprise recurring units of formula (M) with E being of formula (E′-Va) and/or (E′Vb), preferably being selected from;

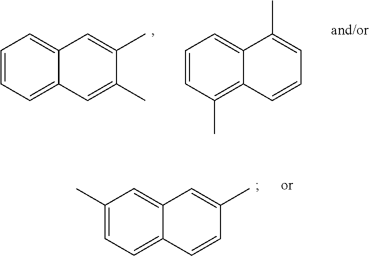

any combination thereof.

In some embodiments, the recurring units (R_{P1}) comprise at least one of the following units:
the recurring units of formula (M) with E being of formula (E′-I), preferably with i=0;
the recurring units of formula (M) with E being of formula (E′-IV), preferably wherein R₃ and R*₃ in formula (E′-IV) are methyl groups; or any combination thereof.

In some embodiments, the copolymer (P1) is such that it comprises:
recurring units (R*_{P1}) wherein the group G_{N} is according to formula (G_{N1}), preferably at least 25 mol. % of the recurring units (R*_{P1}) are such that the group G_{N} is according to formula (G_{N1}), more preferably at least 30 mol. %, even more preferably 35 mol. %;
recurring units (R*_{P1}) wherein the group G_{N} is according to formulas (G_{N1}) and (G_{N6}), preferably at least 35 mol. % of the recurring units (R*_{P1}) are such that the group G_{N} is according to formula (G_{N1}) and (G_{N6}), more preferably at least 40 mol. %, even more preferably 45 mol. %; or
at least recurring units (R*_{P1}) wherein the group G_{N} is according to formulas (G_{N1}), (G_{N4}) and (G_{N6}), preferably at least 50 mol. % of the recurring units (R*_{P1}) are such that the group G_{N} is according to formula (G_{N1}) and (G_{N6}), more preferably at least 60 mol. %, even more preferably 70 mol. %, 80 mol. % or 90 mol. %.

In some embodiments, the copolymer (P1) is such that k is zero and j is 3 in recurring units (R*_{P1}).

In some embodiments, the copolymer (P1) is such that W in recurring units (R*_{P1}) is selected from the group consisting of a bond, —SO₂—, —C(CH₃)₂— and a mixture therefrom. W in recurring units (R*_{P1}) is preferably —C(CH₃)₂— and/or —SO₂—. The copolymer (P1) of the present invention may, for example, comprise first recurring units (R*_{P1}) in which W is —C(CH₃)₂— and second recurring units (R*_{P1}) in which W is —SO₂—.

In some embodiments, the copolymer (P1) is such that the molar ratio of recurring units (R_{P1})/recurring units (R*_{P1}) varies preferably between 1/1 and 20/1, more preferably between 1/1 and 12/1, or betwwen 4/1 and 12/1, or between 4/1 and 10/1.

The molar ratio of recurring units (R_{P1})/recurring units (R*_{P1}) is preferably at least 2.4/1, or at least 3/1, or at least 4/1 and/or at most 25/1, or at most 24/1, or at most 20/1, or at most 12/1, or at most 11/1. In other words, the content of recurring units (R*_{P1}) is preferably at most 29 mol. %, or at most 25 mol. %, or at most 20 mol. %, and/or at least 4 mol. %, or at least 4.75 mol. %, or at least 7.7 mol. %, or at least 8.33 mol. %, or at least 9 mol. %, said mol. % being relative to the total number of moles of recurring units (R*_{P1}) and recurring units (R*_{P1}) in the copolymer (P1).

In some embodiments, the copolymer (P1) comprises collectively at least 50 mol. % of recurring units (R_{P1}) and (R*_{P1}), based on the total number of moles in the copolymer (P1). The copolymer (P1) may for example comprise collectively at least 60 mol. %, at least 70 mol. %, at least 80 mol. %, at least 90 mol. %, at least 95 mol. %, at least 99 mol. % of recurring units (R_{P1}) and (R*_{P1}), based on the total number of moles in the copolymer (P1). The copolymer (P1) may preferably consist essentially of recurring units (R_{P1}) and (R*_{P1}).

According to an embodiment, the copolymer (P1) of the present invention has a Tg ranging from 120 and 250° C., preferably from 170 and 240° C., more preferably from 180 and 230° C., as measured by differential scanning calorimetry (DSC) according to ASTM D3418.

The thio-ether bond —S—R₂ contained in the recurring units (R*_{P1}) possesses several advantages. First, it is a stable non-hydrolyzable linkage which is important for applications in membranes, especially for medical applications. Moreover, it is a highly biocompatible and bio-stable linkage and can therefore be used for hemo-dialysis applications; many biological active molecules contain a thio-ether moiety, e.g. biotin. Yet, this bond can be oxidized to form sulfoxide and sulfone linkages upon treatment with a suitable oxidizing agent like hydrogen peroxide. Further, thio-ethers can be easily alkylated with alkyl halides to form sulfonium salts; polymeric sulfonium salts can then be used for chemical transformations such as epoxidation. In addition, thio-ethers can be coordinated or bonded to heavy metals, therefore the copolymer of the present invention can act as polymeric ligand for metal removal.

Process for preparing the copolymer (P1)

The copolymer (P1) can be prepared by various chemical processes, by free radical thermal reaction, by free radical UV reaction, by base-catalyzed reaction or by nucleophilic-catalyzed reaction.

A process for preparing the copolymer (P1) comprises reacting the allyl/vinylene-functionalized copolymer (P0), as described herein, with a compound R₂—SH,
wherein R₂ is independently selected from the group consisting of:
   (CH₂)ᵤ—COOH, with u being an integer from 1 to 5, preferably u being 1 or 2,
   (CH₂)_{k′}—OH, with k′ being an integer from 1 to 5, preferably k′ being 1 or 2,
   (CH₂)ₚ—NRₐR_{b}, with p being an integer from 1 to 5, and a and b being independently a C1-C6 alkyl or H, with the proviso that Rₐ and R_{b} cannot be both CH₃; p being preferably 1 or 2, and Rₐ and R_{b} being preferably CH₃ or H,
   (CH₂)_{q}—SO₃Na, with q being an integer from 1 to 5, preferably q being 1, 2 or 3,
   (CH₂)ₐ—COCH₃, with a being an integer from 0 to 10,
   (CH₂)ᵣ—Si (OCH₃)₃, with r being an integer from 1 to 5, preferably r being 1, 2 or 3,
   (CH₂)ₛ—(CF₂)ₜ—CF₃, with s being an integer from 1 to 5, preferably 1 or 2, and t being an integer from 1 to 10, preferably from 5 to 9, and
   C(O)— R_{c}, with Rₑ being a C1-C6 alkyl or H, preferably H,
   (CH₂)ᵥ—CH₃, with v being an integer from 5 to 30, preferably v being selected from 8 to 20, and
(CH₂)_{w}—Ar, with w being an integer from 1 to 10 and Ar comprises one or two aromatic or heteroaromatic rings, for example one or two benzene rings.

In some embodiments, the compound R₂—SH used to react with the copolymer (P0) is such that R₂ is independently selected from the group consisting of:
CH₂— COOH,
(CH₂)₂—OH,
(CH₂)₂—NH₂,
(CH₂)₃—SO₃Na,
(CH₂)₃—Si (OCH₃)₃,
(CH₂)₂—(CF₂)₇— CF₃,
CHO,
(CH₂)₉—CH₃, and
CH₂-Ph, with Ph being benzene ring.

The description of any embodiment related to the allyl/vinylene-functionalized copolymer (P0) described herein is applicable to the process of preparing the copolymer (P1) using such copolymer (P0) as a reactant to react with the R₂—SH compound.

The molar ratio of copolymer (P0)/compound (R₂—SH) varies between varies between 0.01/100 and 100/0.01, preferably between 1/100 and 100/1, more preferably between 1/1 and 20/1, yet more preferably between 1/1 and 12/1, yet more preferably between 1/1 and 10/1.

The temperature of the reaction to prepare copolymer (P1) varies between 10° C. and 300° C., preferably between room temperature and 200° C., or more preferably between 35° C. and 100° C.

In some embodiments, the copolymer (P0) used in the reaction to prepare the copolymer (P1) is such that recurring units (R_{P0}) are according to any of the formulae (M1), (M2), (M3), preferably formula (M1). Preferably, i=0 in recurring units (R_{P0}) of any of the formulae (M1), (M2), (M3).

In some embodiments, the copolymer (P0) used in the reaction to prepare the copolymer (P1) is such that recurring units (R_{P0}) are according to the formula (M4).

In some embodiments, the copolymer (P0) used in the reaction to prepare the copolymer (P1) is such that recurring units (R_{P0}) are according to the formula (M4′).

In some embodiments, the copolymer (P0) used in the reaction to prepare the copolymer (P1) is such that recurring units (R_{P0}) are according to the formula (M5a) and/or (M5b), preferably to the formula (M5a′) and/or (M5b′).

In some embodiments, the copolymer (P0) used in the reaction to prepare the copolymer (P1) is such that recurring units (R_{P0}) are according to any of the formulae (M1) wherein i=0, (M4′), (M5a′), (M5b′) or any combinations thereof.

In some embodiments, the reaction to prepare the copolymer (P1) may be carried out under at least one of the following reaction conditions i) to iv):
i) in the presence of a solvent;
ii) in the presence of:
   at least one free radical initiator, and/or
   at least one catalyst;
iil) in the presence of a base;
and/or
iv) by exposure to UV light.

Reaction condition (i): when the reaction to prepare the copolymer (P1) is carried out in a solvent Si, the solvent S₁ is for example a polar aprotic solvent selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof; preferably selected from the group consisting of 1,3-dimethyl-2-imidazolidinone (DMI), N-Methyl-2-pyrrolidone (NMP), dimethylsulfoxide (DMSO), dimethylsulfone (DMSO2), N-butylpyrrolidinone (NBP), N-Ethylpyrrolidone (NEP), N,N′-dimethylacetamide (DMAc), N,N′-dimethylpropyleneurea (DMPU), dimethylformamide (DMF), and/or sulfolane. The polar aprotic solvent S₁ is preferably selected from the group consisting of N-methylpyrrolidone (NMP), N-butylpyrrolidone (NBP), N-ethyl-2-pyrrolidone, N,N-dimethylformamide (DMF), N,N dimethylacetamide (DMAC), 1,3-dimethyl-2-imidazolidinone, tetrahydrofuran (THF), dimethyl sulfoxide (DMSO), chlorobenzene, anisole and sulfolane. The solvent S₁ may also be chloroform or dichloromethane (DCM). The reaction to prepare the copolymer (P1) is more preferably carried out in sulfolane or NMP.

In some embodiments, the solvent S₁ used to prepare the copolymer (P1) is the same as the solvent S₀ used to prepare the copolymer (P0).

In some embodiments, the solvent S₁ used to prepare the copolymer (P1) is different than the solvent S₀ used to prepare the copolymer (P0). For example the solvent S₁ used to prepare the copolymer (P1) may include or be NMP and the solvent S₀ used to prepare the copolymer (P0) may include or be sulfolane, or vice versa.

Reaction condition (ii): the reaction to prepare the copolymer (P1) may be carried out in the presence of:
at least one free radical initiator, preferably 2,2′-Azobis(2-methylpropionitrile) (AIBN) or 2,2′-azobis(2,4-dimethylvaleronitrile (ADVN), and/or
at least one catalyst, preferably selected from peroxides and hydroperoxides.

Reaction condition (iii): when the reaction to prepare the copolymer (P1) is carried out in the presence of a base, the base may be for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base may also be selected from the group consisting of N-Ethyl-N-(propan-2-yl)propan-2-amine (Hunig base), triethylamine (TEA) and pyridine.

Reaction condition (iv): the reaction to prepare copolymer (P1) may be carried out by exposing the reaction mixture to UV light at a wavelength ranging from 300 nm to 600 nm, preferably from 350 nm to 450 nm, more preferably at 365 nm.

According to an embodiment, the amount of the copolymer (P1) at the end of the reaction is at least 10 wt. % based on the total weight of the copolymer (P1) and the solvent, for example at least 15 wt. %, at least 20 wt. % or at least 30 wt. %.

At the end of the reaction, the copolymer (P1) is separated from the other components (salts, base, . . . ) to obtain a solution. Filtration can for example be used to separate the copolymer (P1) from the other components.

The solution containing the copolymer (P1) can then be used as such for reacting the copolymer (P1) with other compounds or for preparing an article, such as a film, sheet or membrane, directly from the solution, or alternatively, the copolymer (P1) can be recovered from the solvent, for example by coagulation or devolatilization of the solvent.

### Applications

The copolymer (P1) of the present invention may be used in the preparation of functional membranes. For example, these membranes may be hydrophobic, hydrophilic, bio-labeled, for example membranes with fluorescent tags.

The copolymer (P1) of the present invention may also be used in the preparation of composite materials. In this application, the functionalities improve the adhesion of the resin to the reinforcing fibers thereby improving performance.

The copolymer (P1) of the present invention may also be used in the preparation of functional coatings. Chemical moieties on the surface of the coatings can be selected to make the coating hydrophobic, hydrophilic, bio-taggable, anti-microbial, anti-fouling and/or UV curable.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### Examples

### Raw Materials

DCDPS (4,4′-dichlorodiphenyl sulfone), available from Solvay Speciality Polymers
K₂CO₃ (Potassium Carbonate), available from Armand products
daBPA (2,2′-diallyl Bisphenol A), available from Sigma-Aldrich, U.S.A.
TMBPF (Tetramethyl Bisphenol F, CAS 5384-21-4) available from TCI America
Isosorbide available from Roquette
2,7—naphthalene diol available from Sigma-Aldrich, U.S.A.
NMP (2-methyl pyrrolidone), available from Sigma-Aldrich, U.S.A.
Sulfolane available from Chevron Phillips
Cysteamine·HCl available from Sigma-Aldrich, U.S.A.
ADVN (2,2′-azobis(2,4-dimethylvaleronitrile)), available from Miller-Stephenson Chemical Co., Inc, U.S.A.

### Test Methods

GPC—Molecular weight (Mn, Mw)—Method 1

The molecular weights were measured by gel permeation chromatography (GPC), using methylene chloride as a mobile phase. Two 5p mixed D columns with guard column from Agilent Technologies were used for separation. An ultraviolet detector of 254 nm was used to obtain the chromatogram. A flow rate of 1.5 ml/min and injection volume of 20 μL of a 0.2 w/v % solution in mobile phase was selected. Calibration was performed with 12 narrow molecular weight polystyrene standards (Peak molecular weight range: 371,000 to 580 g/mol). The number average molecular weight Mn, weight average molecular weight Mw, higher average molecular weight Mz, were reported.

GPC—Molecular weight (Mn, Mw)—Method 2

Viscotek GPC Max (Autosampler, pump, and degasser) with a TDA302 triple detector array comprised of RALS (Right Angle Light Scattering), RI and Viscosity detectors was used. Samples were prepared as ˜2 mg/mL in DMAc/LiBr. Samples were run in DMac with 0.1 w/w % LiBr at 65° C. at 1.0 mL/min through a set of 3 columns: a guard column (CLM1019—with a 20 k Da exclusion limit), a high Mw column (CLM1013 exclusion of 10 MM Daltons relative to Poly Styrene) and a low Mw column (CLM1011—exclusion limit of 20 k Daltons relative to PS). Calibration was done with a single, mono-disperse polystyrene standard of ˜100 k Da. Light Scattering, RI, and Viscosity detectors were calibrated based on a set of input data supplied with the standards. Viscotek's OMNISec v4.6.1 Software was used for data analysis.

### Thermal Gravimetric Analysis (TGA)

TGA experiments were carried out using a TA Instrument TGA Q500. TGA measurements were obtained by heating the sample at a heating rate of 10° C./min from 20° C. to 800° C. under nitrogen.

### ¹H NMR

¹H NMR spectra were measured using a 400 MHz Bruker spectrometer with TCE or DMSO as the deuterated solvent. All spectra are reference to residual proton in the solvent.

### DSC

DSC was used to determine glass transition temperatures (Tg) and melting points (Tm)—if present. DSC experiments were carried out using a TA Instrument Q100. DSC curves were recorded by heating, cooling, re-heating, and then re-cooling the sample between 25° C. and 320° C. at a heating and cooling rate of 20° C./min. All DSC measurements were taken under a nitrogen purge. The reported Tg values were provided using the second heat curve unless otherwise noted.

### I. Preparation of Copolymer (P0-A)

Copolymer (P0-A) was prepared according to Scheme 1.

The polymerization took place in a glass reactor vessel (1 L) fitted with an overhead stirrer, nitrogen inlet and an overhead distillation set-up. The monomers 4,4′-dichlorodiphenyl sulfone (143.58 g), tetramethyl Bisphenol F (116.62 g) and 2,2′-diallyl bisphenol A (13.89 g) were added to the vessel first, followed by the addition of potassium carbonate (71.17 g), and sulfolane (660 g). The reaction mixture was heated from room temperature to 210° C. using a 150° C./mi heating ramp. The temperature of the reaction mixture was maintained for around five hours, depending upon the viscosity of the solution. The reaction was terminated by methyl chloride and sulfolane addition, stopping the heat. The reaction mixture was filtered, coagulated into methanol. The polymer was then washed with methanol, water and finally again with methanol and dried at 110° C. under reduced pressure.

### Characterization of Copolymer (P0-A)

GPC Method 1 (using methylene chloride as a mobile phase):
Mn=16080 g/mol, Mw=83007 g/mol, PDI=5.1
TGA: 434° C.
DSC: 210.35° C.
¹H NMR: The presence of unsaturated groups was confirmed by the appearance of a multiplet at 6.1-6.4 ppm which indicated the incorporation of the 2,2′-diallyl bisphenol A monomer in the polymer (P0-A).

The estimated olefin content was 6.81 mol %.

### II. Preparation of Copolymer (P0-B)

Copolymer (P0-B) was prepared according to the Scheme 2.

The polymerization took place in a glass reactor vessel (1 L) fitted with an overhead stirrer, nitrogen inlet and an overhead distillation set-up. The monomers 4,4′-dichlorodiphenyl sulfone (201 g), 2,7 naphthalenediol (102.02 g) and 2,2′ diallyl bisphenol A (19.43 g) were added to the vessel first, followed by the addition of potassium carbonate (105.45 g), and sulfolane (633 g). The reaction mixture was heated from room temperature to 210° C. using a 150° C./mi heating ramp. The temperature of the reaction mixture was maintained for around five hours, depending upon the viscosity of the solution. The reaction was terminated by methyl chloride and sulfolane addition, stopping the heat. The reaction mixture was filtered, coagulated into methanol and dried at 110° C.

### Characterization of Copolymer (P0-B)

GPC Method 1 (using methylene chloride as a mobile phase):
Mn=13328 g/mol, Mw=46670 g/mol, PDI=3.5
TGA: 492° C.
DSC: 219° C.
¹H NMR: The presence of unsaturated groups was confirmed by the appearance of a multiplet at 6.1-6.4 ppm which indicated the incorporation of the 2,2′-diallyl bisphenol A monomer in the polymer (P0-A). The estimated olefin content was 9.38 mol %.

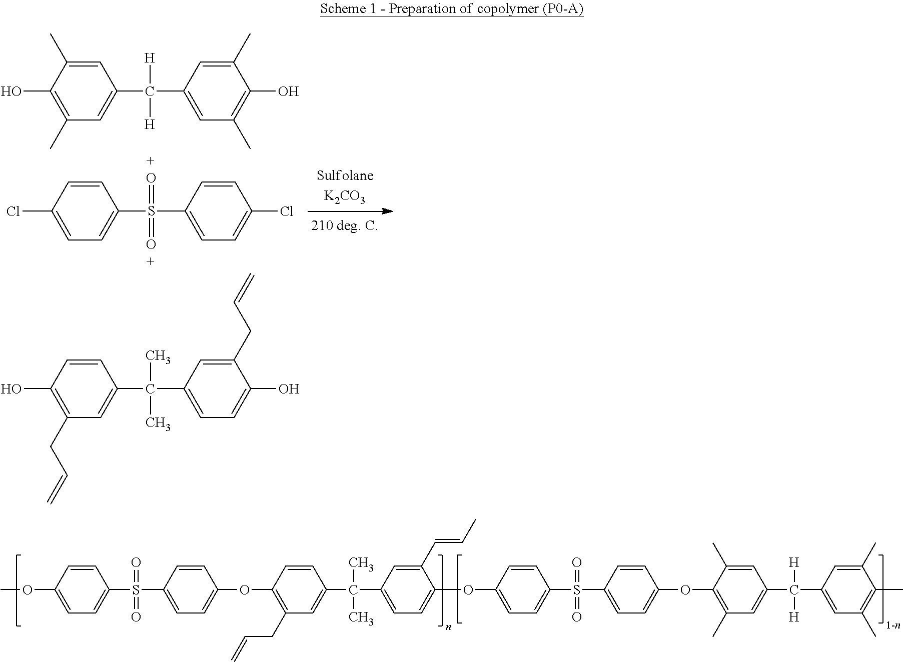

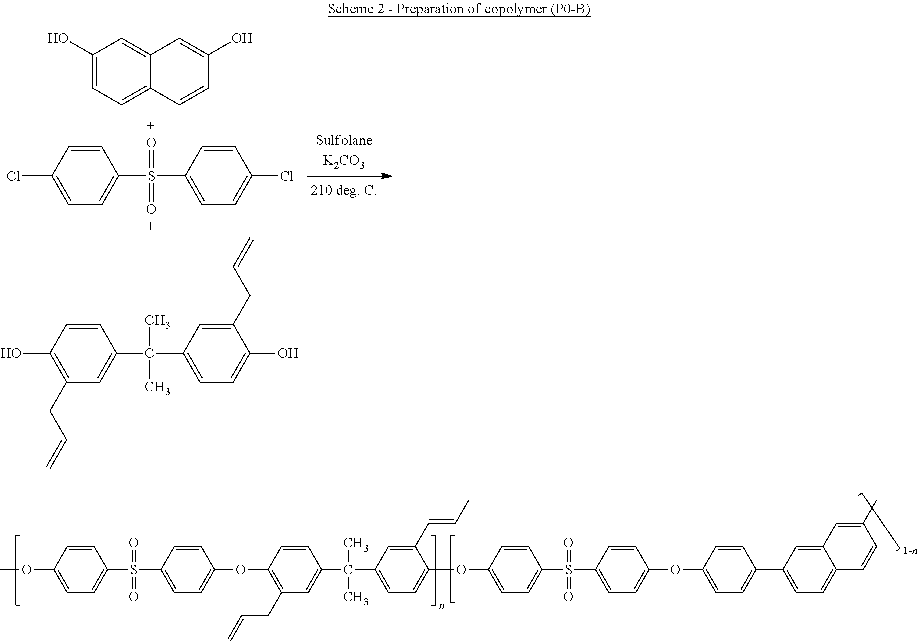

### III. Preparation of Copolymer (P0-C)

Copolymer (P0-C) was prepared according to the Scheme 3.

The polymerization took place in a glass reactor vessel (1 L) fitted with an overhead stirrer, nitrogen inlet and an overhead distillation set-up. The monomers 4,4′-difluorodiphenyl sulfone (259.3 g), Isosorbide (132.98 g) and 2,2′ diallyl bisphenol A (27.75 g) were added to the vessel first, followed by the addition of potassium carbonate (276.41 g), and sulfolane (562.47 g). The reaction mixture was heated from room temperature to 210° C. using a 150° C./mi heating ramp. The temperature of the reaction mixture was maintained for around five hours, depending upon the viscosity of the solution. The reaction was terminated by methyl chloride and sulfolane addition, stopping the heat. The reaction mixture was filtered, coagulated into methanol and dried at 110° C.

### Characterization of Copolymer (P0-C)

GPC Method 2 (in DMAc): Mn=32866 g/mol, Mw=94668 g/mol, PDI=2.88
TGA: 420° C.
DSC: 184° C.
¹H NMR: The olefin groups were identified by the presence of distinct signals between 5-6 ppm confirming the incorporation of the diallyl bisphenol A monomer.

### IV. Preparation of Functionalized Copolymer (P1-A) by Free Radical Reaction

Copolymer (P1-A) was prepared according to the Scheme 4.

In a 500 mL 3-necked flask equipped with a nitrogen inlet, a thermocouple and an overhead stirrer, 30 g of the polymer (P0-A) according to Section I—see Scheme 1—was dissolved in 70 g of NMP and 3.9 g of cysteamine·HCl was added and the reaction mixture heated to 50° C. under nitrogen; then 2.8 g of ADVN was added in one portion. The reaction was continued for 24 hours after which the reaction mass was coagulated into methanol, the precipitated polymer (P1-A) was then washed with methanol, water and then finally with methanol and dried at 110° C. under reduced pressure.

### Characterization of Copolymer (P1-A)

GPC Method 2 (in DMAc): Mw=39456 g/mol, Mn=19674 g/mol, PDI=5.1
DSC: Tg=205.1° C.
TGA: 350.5° C.
The quantitative estimation of the amine functionalization was analyzed by titrating the amine groups. Amine content: 485 microeq/g.

¹H NMR: 0.74 mol % olefin content

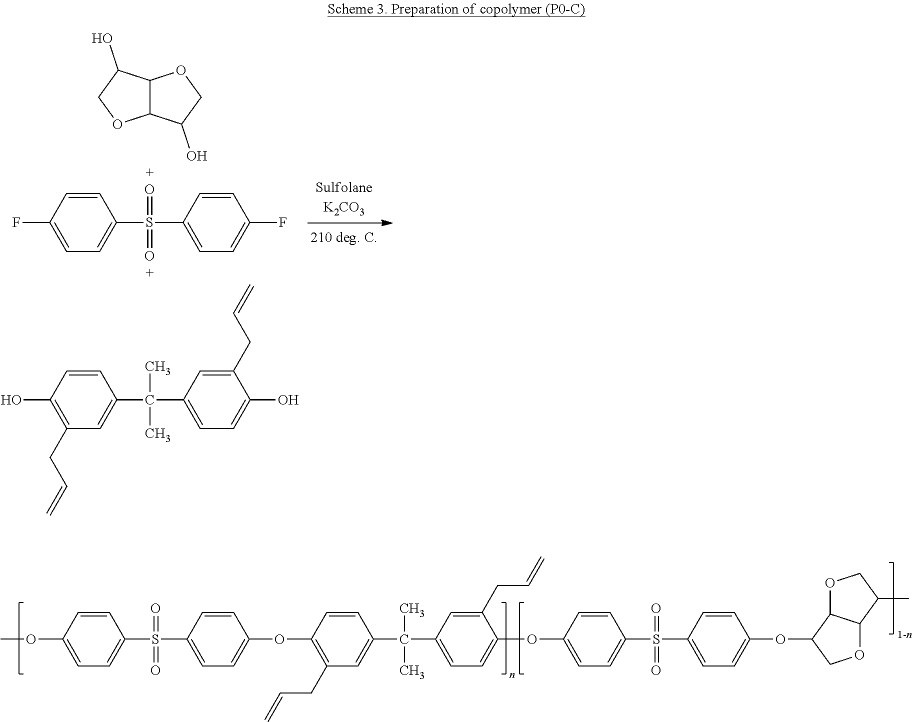

### IV. Preparation of Functionalized Copolymer (P1-A) by Free Radical Reaction

Copolymer (P1-A) was prepared according to the Scheme 4.

In a 500 mL 3-necked flask equipped with a nitrogen inlet, a thermocouple and an overhead stirrer, 30 g of the polymer (P0-A) according to Section I—see Scheme 1—was dissolved in 70 g of NMP and 3.9 g of cysteamine·HCl was added and the reaction mixture heated to 50° C. under nitrogen; then 2.8 g of ADVN was added in one portion. The reaction was continued for 24 hours after which the reaction mass was coagulated into methanol, the precipitated polymer (P1-A) was then washed with methanol, water and then finally with methanol and dried at 110° C. under reduced pressure.

### Characterization of Copolymer (P1-A)

GPC Method 2 (in DMAc): Mw=39456 g/mol, Mn=19674 g/mol, PDI=5.1
DSC: Tg=205.1° C.
TGA: 350.5° C.
The quantitative estimation of the amine functionalization was analyzed by titrating the amine groups. Amine content: 485 microeq/g.

¹H NMR: 0.74 mol % olefin content

### V. Preparation of Functionalized Copolymer (P1-C) by Free Radical Reaction

Copolymer (P1-C) was prepared according to the Scheme 5.

In a 250 mL three-necked flask equipped with a nitrogen inlet, a thermocouple and an overhead stirrer, 18 g of copolymer (P0-C) prepared according to Section III—see Scheme 3—was dissolved in 42 g of NMP and 4.8 g of cysteamine·HCl was added. The reaction mixture was heated to 50° C. under nitrogen then 1.05 g of ADVN was added in one portion. The reaction was continued for 24 hours after which the reaction mass was coagulated into methanol, the precipitated polymer was then washed with methanol, water and then finally with methanol and dried at 110° C. under reduced pressure.

### Characterization of Copolymer (P1-C)

GPC Method 2 (in DMAc): Mw=129353 g/mol, Mn=28142 g/mol, PDI=
4.59
DSC: 187° C.
TGA: 395° C.
Amine content: 385 microeq/g
Olefin content: none detected

Accordingly, the scope of protection is not limited by the description set out above, but is only limited by the claims which follow. Each and every claim is incorporated into the specification as an embodiment of the present invention. Thus, the claims are a further description and are an addition to the preferred embodiments of the present invention.

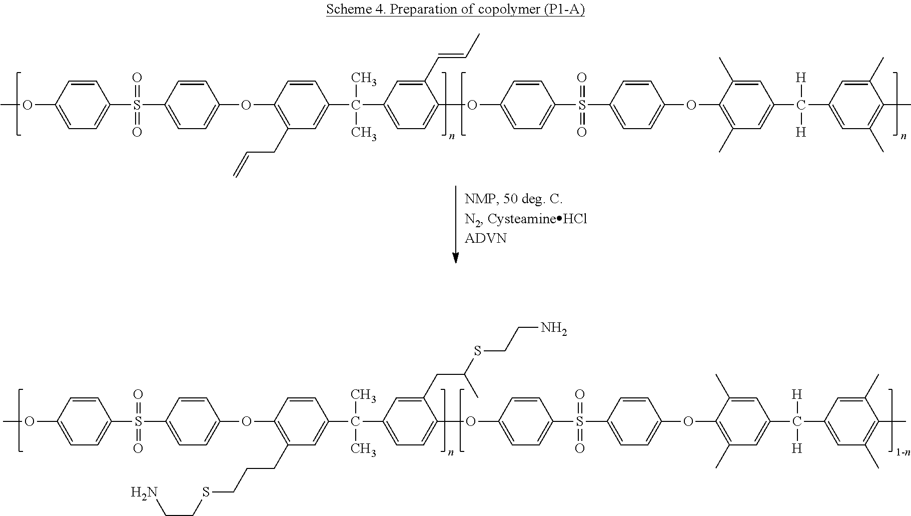

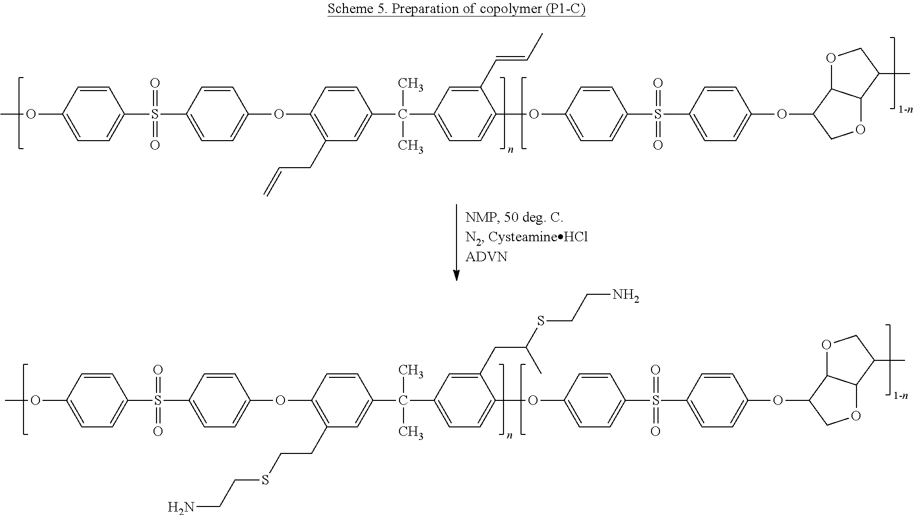

1. A copolymer (P0) comprising collectively at least 70 mol. % of recurring units (R_{P0}) and (R*_{P0}), based on the total number of moles of recurring units in the copolymer (P0),
said recurring units (R_{P0}) being of formula (M): 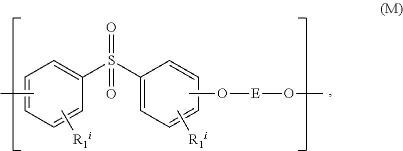
said recurring units (R*_{P0}) being of formula (P): 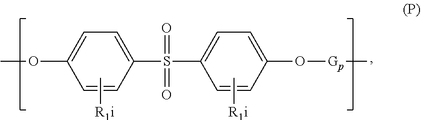
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4;
each of E, equal to or different from each other and at each occurrence, in the formula (M) is selected from the group consisting of those of formulae (E′-I), (E′-II), (E′-III) and (E′-IV): 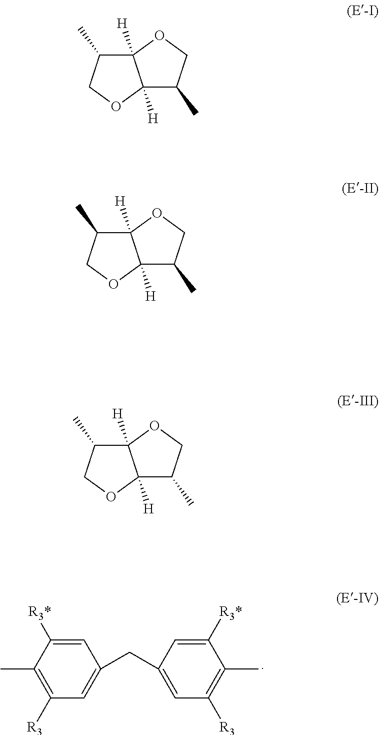
each R₃ in formula (E′-IV) is at each location independently selected from H or an alkyl having from 1 to 5 carbon atoms, preferably an alkyl having from 1 to 5 carbon atoms, more preferably methyl at each location,
each R₃* in formula (E′-IV) is at each location independently selected from an alkyl having from 1 to 5 carbon atoms, preferably methyl at each location;
G_{P} is selected from the group consisting of at least one of the following formulae: 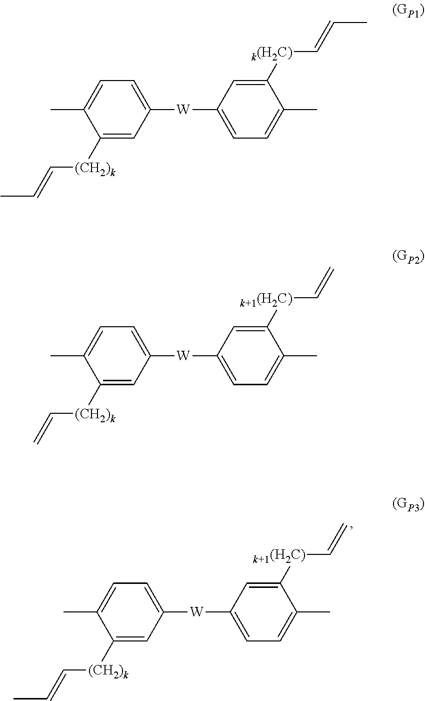
in which
W is a bond, —C(CH₃)₂— or —SO₂— and
each k is independently 0 or an integer from 1 to 4.

2. The copolymer (P0) of claim 1, comprising collectively at least 80 mol. % of the recurring units (R_{P0}) and (R*_{P0}), based on the total number of moles of recurring units in the copolymer (P0).

3. The copolymer (P0) of claim 1, wherein i is zero for each R₁ of the recurring units (R_{P0}) and the recurring units (R*_{P0}).

4. The copolymer (P0) of claim 1, wherein the recurring units (R_{P0}) are according to any of the formulae (M1), (M4′), shown below or any combination thereof:

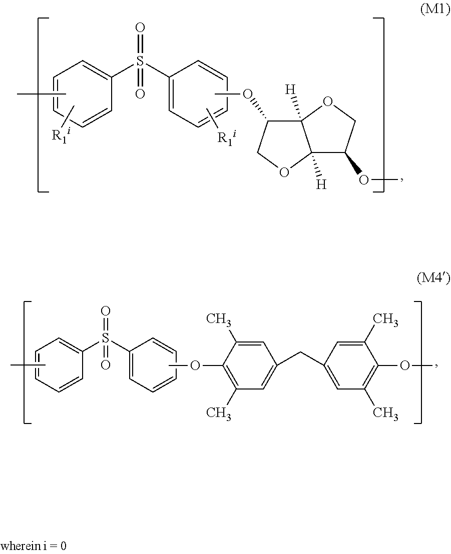

5. (canceled)

6. The copolymer (P0) of claim 1, wherein the molar ratio of recurring units (R_{P0})/recurring units (R*_{P0}) varies between 1/1 and 20/1.

7. A process for preparing the copolymer (P0) of claim 1, comprising reacting, in a polar aprotic solvent and in the presence of a base, at least one aromatic dihydroxy monomer (a1), at least one aromatic sulfone monomer (a2) comprising at least two halogen substituents, and at least one allyl-substituted aromatic dihydroxy monomer (a3),
wherein:
the at least one aromatic dihydroxy monomer (a1) comprises at least 50 wt. %, based on the total weight of the monomer (a1), of at least one diol selected from the group consisting of: isosorbide (1), isomannide (2), isoidide (3), and alkyl-substituted Bisphenol F (4): 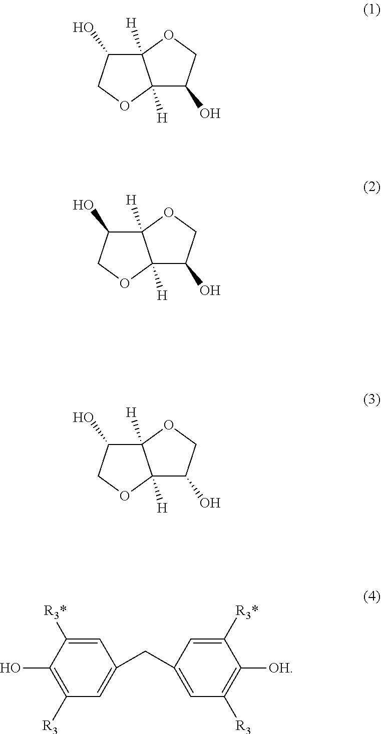
the at least one aromatic sulfone monomer (a2) comprises at least 50 wt. %, based on the total weight of the monomer (a2), of at least one 4,4′-dihalosulfone of following formula: 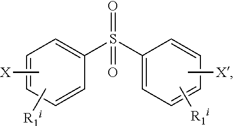
wherein
each R₁ is independently selected from the group consisting of a halogen, alkyl, alkenyl, alkynyl, aryl, carboxylic acid, alkali or alkaline earth metal sulfonate, alkyl sulfonate, alkali or alkaline earth metal phosphonate, alkyl phosphonate, amine and quaternary ammonium;
each i is independently 0 or an integer from 1 to 4; and
X and X′ are independently a halogen selected from the group consisting of Cl and F; and
the at least one allyl-substituted aromatic dihydroxy monomer (a3) comprises at least 50 wt. %, based on the total weight of the monomer (a3), of a 2,2′-diallyl diol selected from the group consisting of: 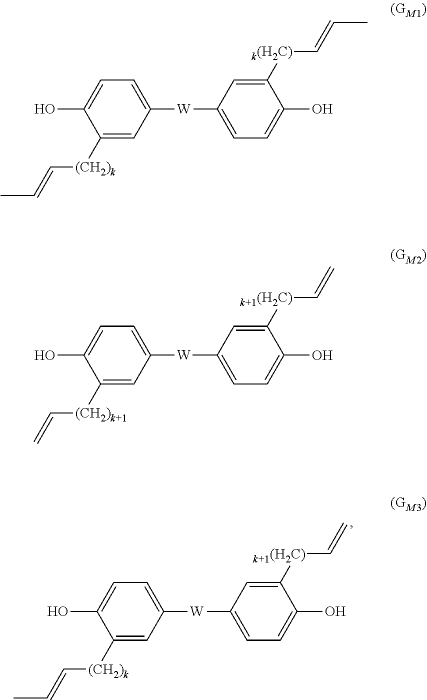
wherein W is a bond, —C(CH₃)₂— or —SO₂—, and each k is independently 0 or an integer from 1 to 4.

8. The process of claim 7, wherein:
the polar aprotic solvent S₀ is selected from the group consisting of N-methylpyrrolidone (NMP), N-butylpyrrolidone (NBP), N-ethyl-2-pyrrolidone, N,N-dimethylformamide (DMF), N,N dimethylacetamide (DMAc), 1,3-dimethyl-2-imidazolidinone, tetrahydrofuran (THF), dimethyl sulfoxide (DMSO), chlorobenzene, anisole and sulfolane; and/or
the base is selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide; and/or
the molar ratio of [(a1)+(a3)]/(a2) is from 0.9 to 1.1.

9. The process of claim 7, wherein the content of the monomer (a3) is at most 29 mol. %, said mol. % being relative to the total number of moles of the dihydroxy monomer (a1) and the monomer (a3).

10. A copolymer (P1) comprising:
recurring units (R_{P1}) of formula (M): 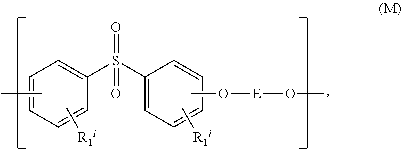
functionalized recurring units (R*_{P1}) of formula (N): 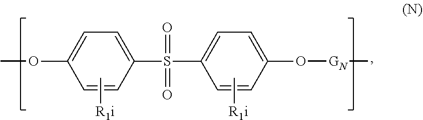
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4;
G_{N} is selected from the group consisting of at least one of the following formulae (G_{N1}) to (G_{N6}): 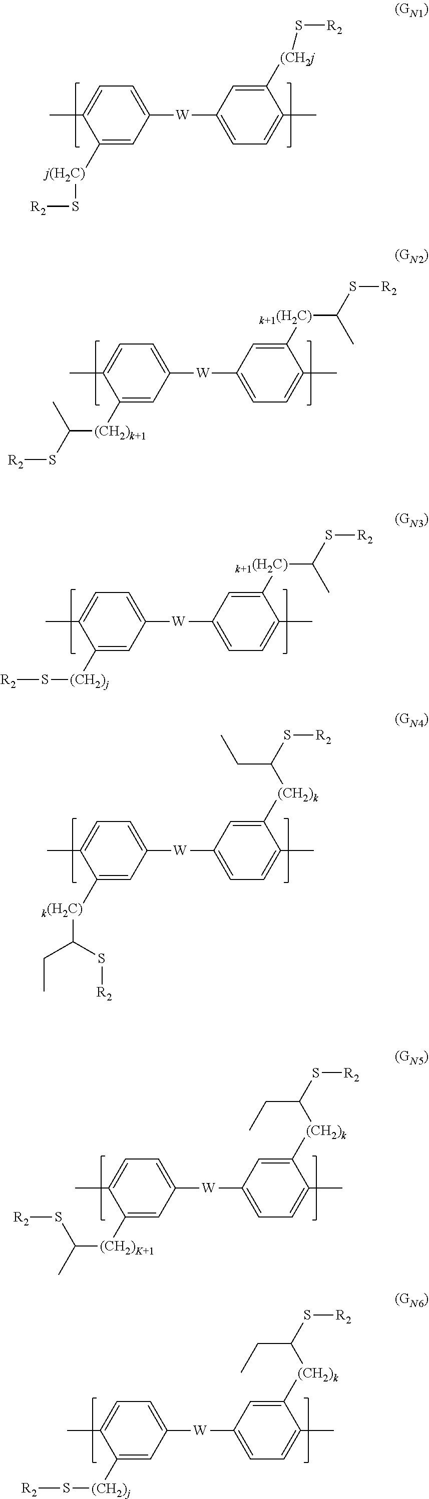
W is a bond, —C(CH₃)₂— or —SO₂—;
each k is independently 0 or an integer from 1 to 4;
each j is independently an integer from 3 to 7;
each R₂ is independently selected from the group consisting of:
(CH₂)ᵤ—COOH, with u being an integer from 1 to 5,
(CH₂)_{k′}—OH, with k′ being an integer from 1 to 5,
(CH₂)ₚ—NRₐR_{b}, with p being an integer from 1 to 5, and Rₐ and R_{b} being independently a C1-C6 alkyl or H, with the proviso that Rₐ and R_{b} cannot be both CH₃,
(CH₂)_{q}—SO₃Na, with q being an integer from 1 to 5,
(CH₂)ₐ—COCH₃, with a being an integer from 0 to 10,
(CH₂)ᵣ—Si (OCH₃)₃, with r being an integer from 1 to 5,
(CH₂)ₛ—(CF₂)ₜ—CF₃, with s being an integer from 1 to 5 and t being an integer from 1 to 10,
C(O)— R_{c}, with R_{c} being a C1-C6 alkyl or H,
(CH₂)ᵥ—CH₃, with v being an integer from 5 to 30, and
(CH₂)_{w}—Ar, with w being an integer from 1 to 10 and Ar comprising one or two aromatic or heteroaromatic rings; and
each of E, equal to or different from each other and at each occurrence, is selected from the group consisting of those of formulae (E′-1), (E′-II), (E′-Ill), (E′-IV): 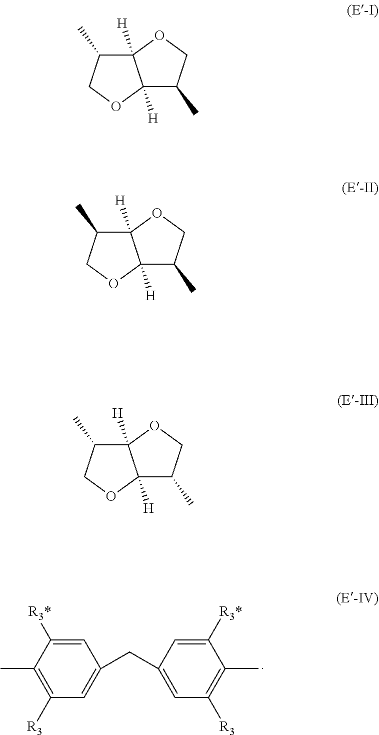
each R³ is at each location independently selected from H or an alkyl having from 1 to 5 carbon atoms, and
each R₃* is at each location independently selected from an alkyl having from 1 to 5 carbon atoms.

11. The copolymer (P1) of claim 10, wherein i is zero for each R₁ of the recurring units (R_{P1}) and (R*_{P1}) and/or wherein k is 0 and j is 3 in the recurring units (R*_{P1}).

12. The copolymer (P1) of claim 10, wherein the molar ratio of recurring units (R_{P1})/recurring units (R*_{P1}) varies between 1/1 and 20/1.

13. (canceled)

14. The copolymer (P1) of claim 10, wherein the recurring units (R_{P1}) comprise:
the recurring units of formula (M) with E being of formula (E′-1);
the recurring units of formula (M) with E being of formula (E′-IV), wherein R₃ and R*₃ in formula (E′-IV) are methyl groups; or
any combination thereof.

15. The copolymer (P1) of claim 10, wherein R₂ in the formulae (G_{N1}), (G_{N2}), (G_{N3}), (G_{N4}), (G_{N5}) or (G_{N6}) in the recurring units (R*_{P1}) is independently selected from the group consisting of:
—CH₂— COOH,
(CH₂)₂—OH,
(CH₂)₂—NH₂,
(CH₂)₃—SO₃Na,
(CH₂)₃—Si (OCH₃)₃,
(CH₂)₂—(CF₂)₇— CF₃,
CHO,
(CH₂)₉—CH₃, and
CH₂-Ph, with Ph being benzene ring.

16. The copolymer (P1) of claim 10, comprising collectively at least 70 mol. % of the recurring units (R_{P1}) and (R*_{P1}), based on the total number of moles of recurring units in the copolymer (P1).

17. A process for preparing the copolymer (P1) of claim 10, comprising reacting, in a solvent S₁, a copolymer (P0) with a compound of formula (1):
R₂—SH, (I)
wherein each R₂ is independently selected from the group consisting of:
(CH₂)ᵤ—COOH, with u being an integer from 1 to 5,
(CH₂)_{k′}—OH, with k′ being an integer from 1 to 5,
(CH₂)ₚ—NRₐR_{b}, with p being an integer from 1 to 5, and Rₐ and R_{b} being independently a C1-C6 alkyl or H, with the proviso that Rₐ and R_{b} cannot be both CH₃,
(CH₂)_{q}—SO₃Na, with q being an integer from 1 to 5,
(CH₂)ₐ—COCH₃, with a being an integer from 0 to 10
(CH₂)ᵣ—Si (OCH₃)₃, with r being an integer from 1 to 5,
(CH₂)ₛ—(CF₂)ₜ—CF₃, with s being an integer from 1 to 5 and t being an integer from 1 to 10,
C(O)— R_{c}, with R_{c} being a C1-C6 alkyl or H,
(CH₂)ᵥ—CH₃, with v being an integer from 5 to 30, and
(CH₂)_{w}—Ar, with w being an integer from 1 to 10 and Ar comprising one or two aromatic or heteroaromatic rings, and
wherein the copolymer (P0) comprises collectively at least 70 mol. % of recurring units (R_{P0}) and (R*_{P0}), based on the total number of moles of recurring units in the copolymer (P0),
said recurring units (R_{P0}) being of formula (M): 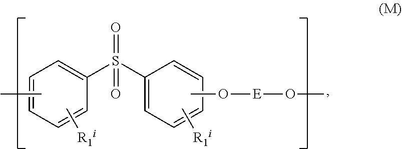
said recurring units (R*_{P0}) being of formula (P): 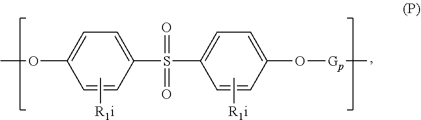
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4;
each of E, equal to or different from each other and at each occurrence, in the formula (M) is selected from the group consisting of those of formulae (E′-1), (E′-II), (E′-III) and (E′-IV): 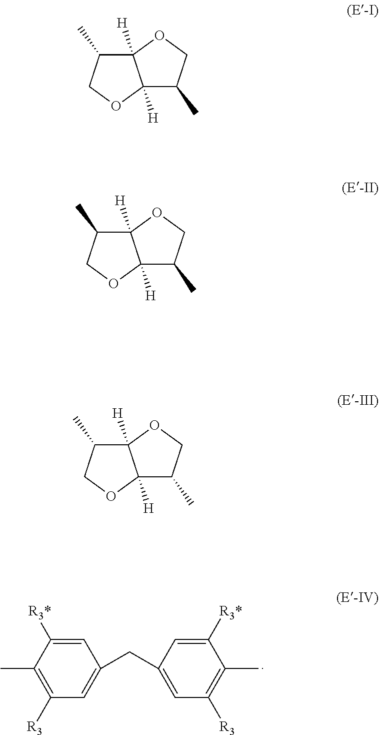
each R₃ in formula (E′-IV) is at each location independently selected from H or an alkyl having from 1 to 5 carbon atoms,
each R₃* in formula (E′-IV) is at each location independently selected from an alkyl having from 1 to 5 carbon atoms,
G_{P} is selected from the group consisting of at least one of the following formulae: 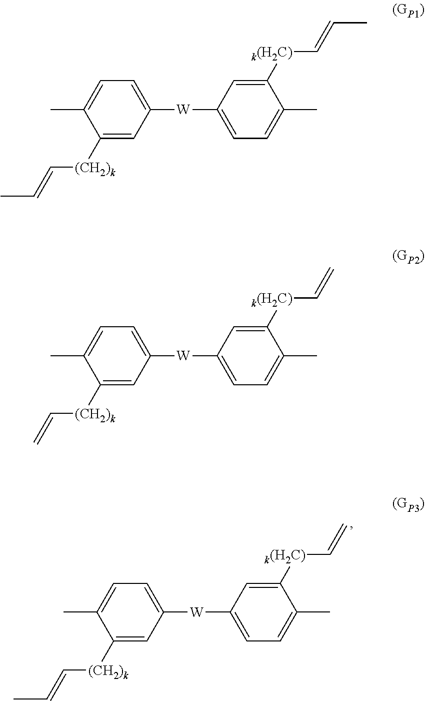
in which
W is a bond, —C(CH₃)₂— or —SO₂—, and
each k is independently 0 or an integer from 1 to 4.

18. The process of claim 17, being carried out under at least one of the following reaction conditions i) to iv):
i) in a solvent S₁ selected from the group consisting of N-methylpyrrolidone (NMP), N-butylpyrrolidone (NBP), N-ethyl-2-pyrrolidone, N,N-dimethylformamide (DMF), N,N dimethylacetamide (DMAC), 1,3-dimethyl-2-imidazolidinone, tetrahydrofuran (THF), dimethyl sulfoxide (DMSO), chlorobenzene, anisole, chloroform, dichloromethane (DCM) and sulfolane;
ii) in the presence of:
at least one free radical initiator, and/or
at least one catalyst;
iii) in the presence of a base;
and/or
iv) by exposure to UV light at a wavelength ranging from 300 nm to 600 nm.

19. A method for the preparation of a membrane, a composite material or a coating, comprising using the copolymer (P1) of claim 10.
